(19) United States
(12) Patent Application Publication
(10) Pub. No.: US 2010/0124463 A1
(43) Pub. Date: May 20, 2010

(54) Method for forming a solid soil base with a material comprising soil and spent lime

(76) Inventor: Robert V. Rogers, Washington, MI (US)

Correspondence Address: Eric T. Jones;Reising Ethington P.C., Suite 1850, 755 West Big Beaver Road, Troy, MI, 48084, US

(21) Appl. No.: 12/620,308

(22) Filed: Nov. 17, 2009

Related U.S. Application Data
(60) Provisional application No. 61/115,192, filed on Nov. 17, 2008.

(51) Int. Cl. C09K 17/06

(52) U.S. Cl. 405/266

(57) ABSTRACT

A method for filling and/or building-up land areas by creating a solid soil base through the deposition of a generally non-reactive composite fill material made by intermixing spent lime and soil such that moisture content of the spent lime is distributed through the material.

### BACKGROUND OF THE INVENTION

1. Technical Field

The subject invention is directed toward methods for filling depressed land areas and/or building up land areas with backfill material and for making backfill material.

2. Description of the Related Art

Previously unusable land areas such as gravel pits, excavation sites, areas needing fill, and areas of soft or unstable ground can often be put to beneficial use once backfilled (filled and/or built-up) with fill material. For example, once filled and/or built-up, such land sites have been used for golf courses, public parks, camp grounds, building pads, retention berms, earth dams and the like. Fill material commonly used for filling or building-up such land sites has traditionally included sand, clay, gravel, and broken concrete or bricks. Such fill material can be expensive, and the resulting load bearing characteristics can be marginal. It's expensive!!!

Soil stabilization techniques that produce superior load bearing characteristics have long existed. These techniques typically involve using a hydratable form of lime intermixed with other materials to form a concrete-like base. Such hydratable forms of lime draw moisture from the surrounding soil to form a dry solid soil base on which construction may take place. Examples of such techniques are disclosed in U.S. Pat. No. 2,815,294 to Havelin and U.S. Pat. No. 4,373,958 to Jones.

The two hydratable forms of lime typically used include quick lime, CaO, and slaked lime, Ca(OH).sub.2. While yielding superior load bearing characteristics, both forms of lime have significant disadvantages. For example, slaked lime produces a great deal of dust while being intermixed with surrounding soil. Consequently, workers and the surrounding environment are exposed to lime dust. Even more problematic is the caustic properties associated with quick lime, which make the handling and spreading of quick lime especially difficult. Additionally discouraging is the cost of obtaining both of these hydratable forms of lime.

Some of the drawbacks associated with the use of hydratable limes have been mitigated by the use of specially developed spreading techniques, as shown in U.S. Pat. No. 3,793,841 to Dozsa. Also, the use of polymeric additives in conjunction with hydratable lime has been used, as shown in U.S. Pat. No. 4,134,862 to Eden.

The use of portland cement as a fill material is also quite common. As with the hydratable lime materials, use of portland cement also relies upon the absorption of moisture from the surrounding soil to dry out wet unstable soil and form a solid base for supporting construction. U.S. Pat. No. 4,464,200 to Duval is illustrative of the use of portland cement.

### SUMMARY OF THE INVENTION

A method is provided for filling and/or building-up land areas by providing a substance comprising spent lime, providing soil, and forming a generally non-reactive composite fill material by intermixing the substance with the soil such that moisture content of the spent lime is distributed through the material. A solid soil base is then created by depositing the composite fill material.

Alternatively, the step of providing a substance comprising spent lime may include generating spent lime by providing a solution of water and dissolved minerals, precipitating a residue and providing softened water by adding lime to the solution, and removing the residue from the softened water. The residue may then be further processed to form spent lime of a desired consistency.

Alternatively, the step of further processing the residue to form spent lime may include reducing water content of the residue by storing the residue in a containment and allowing insoluble precipitates to settle-out and form a layer of spent lime. The spent lime may then be removed from the layer.

Alternatively, the step of further processing the residue to form spent lime may include compressing the residue sufficiently to form a spent lime cake of a desired consistency and dampness.

Alternatively, the step of forming a spent lime cake may include compressing the residue using one or more press devices such as a plate and frame press, a vacuum drum press, a belt press, or a filter press.

Alternatively, the spent lime may be analyzed for unacceptable amounts of hazardous materials.

Alternatively, the step of providing soil may include providing soil comprising material more coarse than the spent lime.

Alternatively, the step of providing soil may include providing soil that includes sand.

Alternatively, the step of intermixing may include dumping the wet spent lime in a mound, dumping the soil in a mound, and then intermixing the mounds.

Alternatively, the step of intermixing may include providing a tossed mixture by tossing spent lime and soil together using excavation machinery.

Alternatively, further blending and aerating of the tossed mixture may be accomplished by bulldozing.

Alternatively, spent lime and soil may be provided with respective moisture contents, and may be intermixed such that the resulting composite fill material has an approximate 15% moisture content.

Alternatively, spent lime and soil may be provided at a ratio in the range of 9:1 to 1:9.

Alternatively, spent lime and soil may be provided at a ratio in the range of 3:2 to 2:3.

Alternatively, undesirable elements may be screened-out of the intermixed substance and soil.

Alternatively, the substance may be intermixed with soil within a rotating drum. The drum may include holes that allow composite fill material of a desired consistency to pass through the drum wall while causing undesirable elements of the intermixed substance and soil to pass out a downstream end of the drum.

Alternatively, intermixing within a rotating drum may include controlling a rate of axial movement of the spent lime and soil through the drum by adjusting drum tilt.

Alternatively, intermixing with a rotating drum may include providing a drum comprising a helical blade fixed along and around an inner circumferential surface of the drum. The blade may be configured to propel the spent lime and soil axially through the drum in a direction toward an outlet end of the drum and to assist in blending the spent lime and soil.

Alternatively, intermixing with a rotating drum may include controlling a rate of drum rotation to influence such characteristics as degree of blending, moisture distribution, and degree of aeration of spent lime and soil passing through the drum.

Alternatively, intermixing with a rotating drum may include providing a drum comprising smaller holes at an upstream end and larger holes at a downstream end.

Alternatively, intermixing with a rotating drum may include providing a drum comprising no holes at an upstream end.

### BRIEF DESCRIPTION OF THE DRAWINGS

Other advantages of the subject invention will be readily appreciated as the invention become better understood by reference to the following detailed description when considered in connection with the accompanying drawings wherein:

FIG. 1 is a flow chart summarizing the general steps of the subject method;

FIG. 2 is a perspective view of a settling pond showing the wet spent lime being removed therefrom;

FIG. 3 is a schematic front view of a press disposed on the second story of a structure in a position to drop wet spent lime cake product into the bed of a truck;

FIG. 4 is a perspective view showing the intermixing of the wet spent lime with soil and the subsequent placement of the composite mixture into a depressed land area;

FIG. 5 is a schematic front view of a blending apparatus for blending wet spent lime and soil according to the invention;

FIG. 6 is a schematic orthogonal view showing wet spent lime and soil being introduced into a rotating drum of the blending apparatus of FIG. 5;

FIG. 7 is a schematic front view of an alternative drum portion of the blending apparatus of FIG. 5; and

FIG. 8 is a schematic front view of another alternative drum portion of the blending apparatus of FIG. 5.

### DETAILED DESCRIPTION OF THE PREFERRED EMBODIMENT

As an initial overview to the subject method, FIG. 1 has been included in the form of a flow chart showing the major steps involved. Each of the major steps shown in FIG. 1 will be discussed in more detail subsequently. By way of introduction, however, the subject method is a method for filling and/or building-up land areas and includes the general steps of: generating or otherwise providing a substance comprising spent lime 14 of a type that will not absorb an appreciable amount of water, forming a generally non-reactive composite fill material 22 by intermixing the substance with soil 18 such that moisture content of the spent lime is distributed through the substance, and creating a solid soil base by depositing the composite fill material, e.g., by fill and/or build-up a land area with the composite fill material.

As indicated in FIG. 1, the first step of the subject method involves generating spent lime 14. In general terms, spent lime 14 may be generated by adding lime to unsoftened water, i.e., a solution comprising water and dissolved minerals, in order to precipitate out from the unsoftened water minerals that cause water hardness. Its usefulness in precipitating out such minerals is one reason that lime, CaO, is commonly used to soften water in large scale water treatment processes. Calcium is the primary mineral contributing to water hardness but other minerals such as magnesium and iron also contribute to lesser extents. In practice, water treatment facilities acquire unsoftened water from groundwater or surface water sources. Lime is subsequently added to the unsoftened water to react with the water hardening minerals found therein and form insoluble precipitates therewith. These insoluble precipitates form a residue that may then be further processed to form spent lime 14 of suitable or desired consistency for use in composite fill material 22.

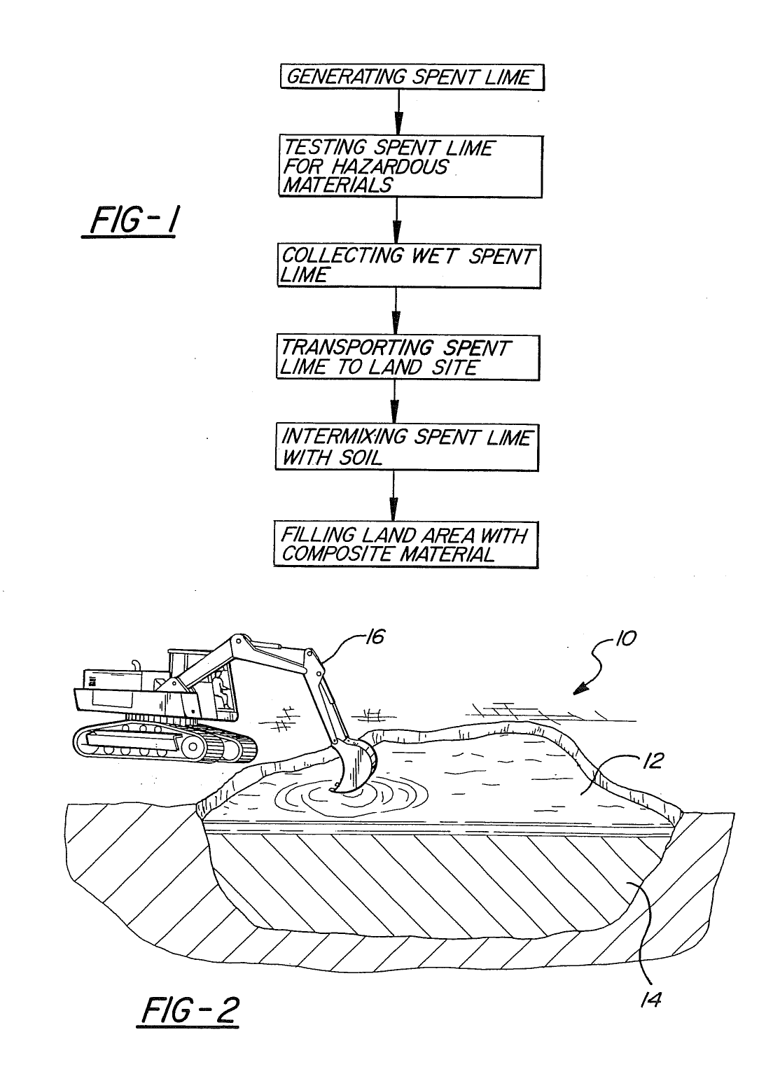

One way to achieve a suitable consistency of spent lime 14 is to remove the residue from the softened water and store it in containments such as settling ponds 10 as shown in FIG. 2. Over time, the residue is “de-watered”, i.e., is reduced in water content, by allowing insoluble precipitates settle out and form a layer on the bottom of the pond 10. The remaining de-watered, but damp insoluble precipitates, hereinafter referred to as spent lime 14, are substantially comprised of calcium carbonate (at least half by weight). Unlike quick lime, CaO or slaked lime, Ca(OH).sub.2, spent lime 14, which may be 99% non-reactive will not react appreciably or absorb an appreciable amount of water. Usually, the spent lime 14 comprises a damp mixture of approximately 90% calcium carbonate, CaCO.sub.3, with the remaining 10% comprising magnesium hydroxide, Mg(OH).sub.2, and other insoluble salts; however, the relative proportions of each constituent of the spent lime 14 vary with the unique geological and environmental surroundings the water has previously been exposed to. Again, where the residue is stored in a settling pond 10, over time, the spent lime 14 builds up in the bottom of the settling pond 10 and may subsequently be removed and disposed therefrom.

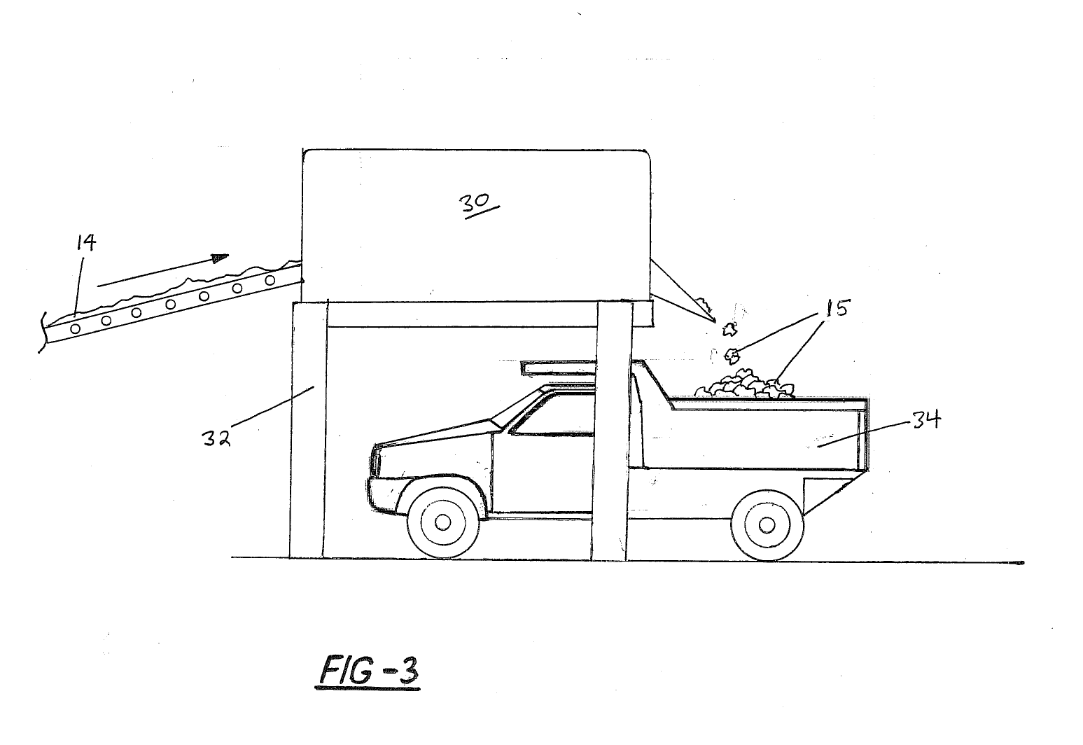

Another way to process spent lime 14 to obtain a consistency and dampness suitable for use in composite fill material 22 is to remove the residue from softened water and form it into a cake 15 of spent lime using any suitable compression device 30 known in the art. Such a compression device 30 may include, for example, a plate and frame press, a vacuum drum press, a belt press; and/or a filter press. As shown in FIG. 3, such a compression device 30 may be supported at a sufficient height, e.g., on the second floor or story of a building 32 or other suitable structure, to allow resulting cake-form spent lime 15 to be dropped onto the bed of a truck 34 parked beneath the level of the compression device 30.

As a precautionary step, samples of the spent lime 14 should be analyzed for unacceptable amounts of hazardous materials such as; silver, barium, mercury, phosphorous, zinc, copper, and depending upon the water source, possibly organic molecules including PCBs. Acceptable levels for these and other hazardous materials may be regionally determined. The State DNR (now called DEP) or other governmental agencies may be of assistance in determining acceptable levels of these and other materials. By conducting precautionary analytical testing of the spent lime, the safety of the resulting composite fill and surrounding land area can be assured.

The spent lime 14 used in the composite fill material 22 and in the subject method may be collected from water softening facilities by draining the water from the settling ponds, leaving behind wet spent lime 14 in the form of a slurry-like mixture consisting of roughly 60% spent lime and 40% water. The wet spent lime is typically removed from settling ponds, as shown in FIG. 2. More specifically, the settling pond, generally shown at 10, is drained leaving behind only a limited amount of water 12. Beneath the water 12, lies a layer of wet spent lime 14. The wet spent lime 14 is removed from the pond by the use of a back hoe 16 or like equipment.

Once removed from the settling pond 10, the wet spent lime 14 is transported, preferably by truck, to the selected land site where it is intermixed with soil 18 to form a composite fill material 22. The soil 18 used to form the composite fill material 22 may be native soil found about the land site, however, to obtain optimum results, the soil 18 should comprise a larger portion of sand or other material coarser than the spent lime 14. The desired fill material characteristics are achieved by, among other things, void filling through an intermixing of desired particle sizes. Ideally, the soil 18 comprises bankrun sand. If the native soil does not contain a large portion of sand, i.e. the native soil is primarily clay, gravel, or silt, sand from a non-native source may be transported to the land site and may be substituted for native soil.

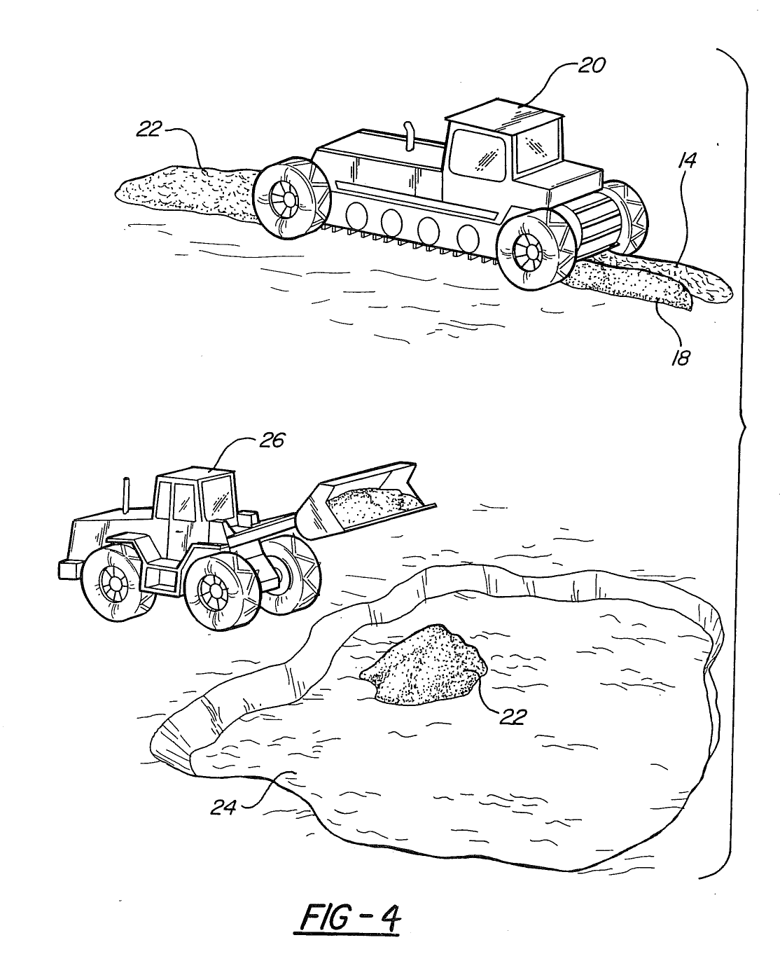

The wet spent lime 14 and soil 18 may be intermixed at a location adjacent the area to be filled. Although any one or more of many suitable techniques can be used to intermix the wet spent lime 14 and soil 18, three particular techniques have been found to work especially well. One of those techniques is shown in FIG. 4 and involves dumping the wet spent lime 14 in an elongated narrow mound or row. The soil 18 may likewise dumped in an elongated narrow mound or row, parallel to the wet spent lime mound located a few feet away. Subsequently, a mixing machine 20, which may be of a type typically used for composting applications, may be used to intermix the mound of wet spent lime 14 with the mound of soil 18. Several passes over the parallel mounds may be required to properly mix the wet spent lime 14 with the soil 18, depending of course, upon the relative proportions of soil to spent lime being mixed. The spent lime 14 being intermixed with the soil 18 may be wet. Where the spent lime 14 is wet, the mixing operation generates little or no dust. Such moisture content of the wet spent lime 14 allows for relatively quick and easy intermixing with the soil 18 to form a dense, composite fill material 22.

To provide desirable compacting characteristics, the resulting fill material 22 may preferably include roughly 15% moisture. In other words, spent lime 14 and soil 18 are provided having respective moisture contents such that their intermixing provides composite fill material 22 having an approximate 15% moisture content. The moisture content of the composite fill 22 may preferably be monitored on site by the use of nuclear density meters, or other like apparatus commonly used for measuring moisture content of soils. The remaining 85% of the composite fill material 22 may comprise soil 18 and spent lime 14. The ratio of soil 18 to spent lime 14 in the composite fill material 22 may vary drastically depending upon the requirements for the fill material 22, the nature of the surrounding land area, the quantity of spent lime 14 to be disposed of, etc. Depending upon the results of an evaluation of these variables, the ratio of soil 18 to spent lime 14 selected for a given application may vary anywhere from 9:1 to 1:9. Studies thus far indicate that optimum load bearing characteristics are achieved from fill consisting of roughly equal portions of soil 18 and spent lime 14, i.e. ratios from 3:2 to 2:3 depending, of course, upon the nature or characteristics of the specific soil used.

Another of the preferred techniques for intermixing is to provide composite fill material 22 by simply tossing spent lime 14 and soil 18 together using excavation machinery such as the backhoe 16 shown in FIG. 2. The “tossed” mixture may then be further blended and aerated by bulldozing.

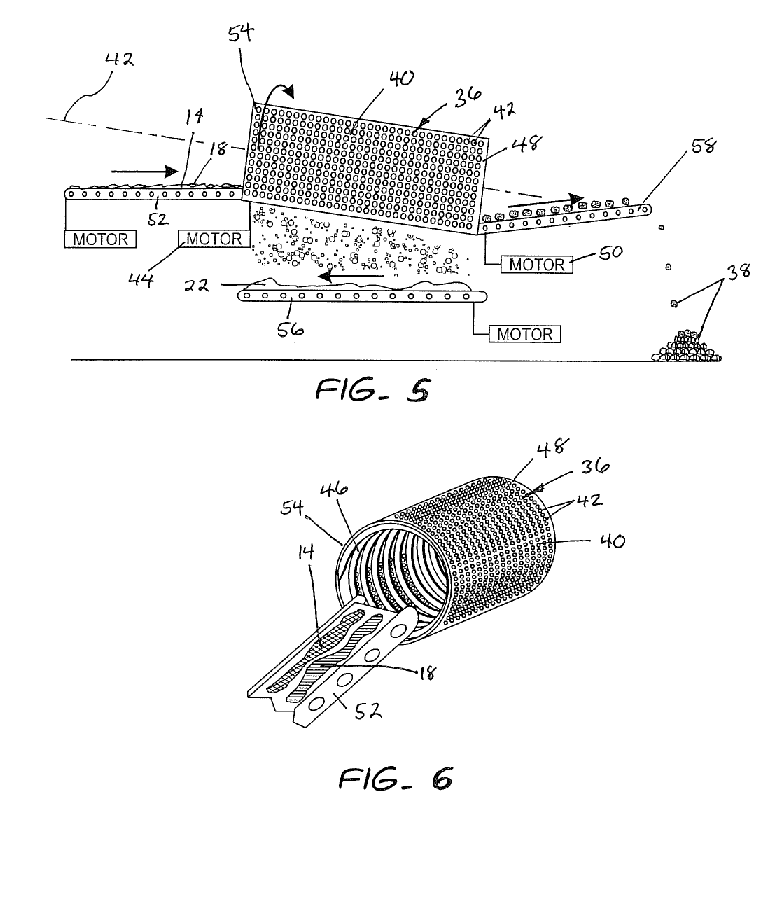

The remaining preferred technique for intermixing wet spent lime 14 and soil 18 is shown in FIGS. 5 and 6 and involves forming composite fill material 22 by passing wet spent lime 14 and soil 18 at a desired ratio through a blending apparatus 36 configured to blend and aerate the spent lime 14 and soil 18. The blending apparatus 36 may also be configured to screen-out undesirable elements 38 of the resulting mixture.

The blending apparatus 36 may include a generally cylindrical drum 40 supported for rotation on an axis 42 that is generally perpendicular or slightly angled relative to Earth gravity as best shown in FIG. 5. The drum 40 may include a cylindrical wall comprising an array of holes 42 in the form of perforations or openings in a grate or screen. The holes 42 may be configured and sized to allow composite fill material 22 of a desired consistency (particle size, stickiness, moisture content, chunk size, etc.) to fall through the wall of the drum rather than being passed out a downstream end of the drum.

As shown in FIG. 5, the blending apparatus 36 may further include a motorized variable-tilt mechanism 44 configured to allow an operator to control the rate of axial movement of the spent lime 14 and soil 18 through the drum 40 by adjusting drum tilt. Alternatively, or in addition, a helical blade 46 may be fixed along and around an inner circumferential surface of the drum 40 and configured to both propel the spent lime 14 and soil 18 axially through the drum in a direction toward an outlet end 48 of the drum 40, and to assist in blending the lime 14 and soil 18 as shown in FIG. 6.

The blending apparatus 36 may further include a motorized rotational speed control 50 configured to allow an operator to control the rate of drum rotation. The rotational speed control 50 may be used to influence the degree of blending, moisture distribution, and degree of aeration of spent lime 14 and soil 18 passing through the drum 40. Where the apparatus 36 includes a helical blade 46, the rate of axial flow of material through the drum 40 may also be influenced by adjusting the rate of drum rotation.

A feed conveyor 52 may be positioned and configured to feed wet spent lime 14 and soil 18 into an upstream end 54 of the drum 40 as best shown in FIG. 6. An output conveyor 56 may be positioned and configured to collect and remove composite fill material 22 exiting through the wall of the drum 40 as shown in FIG. 5, and a de-stoning conveyor 58 may be positioned and configured to carry away from the downstream end 48 of the drum 40 stones and other objects 38 too large to pass through the holes 42 in the drum wall, and/or other elements of the composite fill material 22 of a consistency that prevents them from passing through the holes in the drum wall.

As spent lime 14 and soil 18 move through the drum 40 the spent lime 14 and soil 18 are blended and aerated by rotation of the drum 40 which continuously picks up and throws together the lime 14 and soil 18. While blending, the lime 14 and soil 18 may be urged axially through the drum 40 by the helical blades 46 and/or by tilting the drum such that the upstream end 54 of the drum 40 is higher than the downstream end 48 of the drum 40 as best shown in FIG. 5.

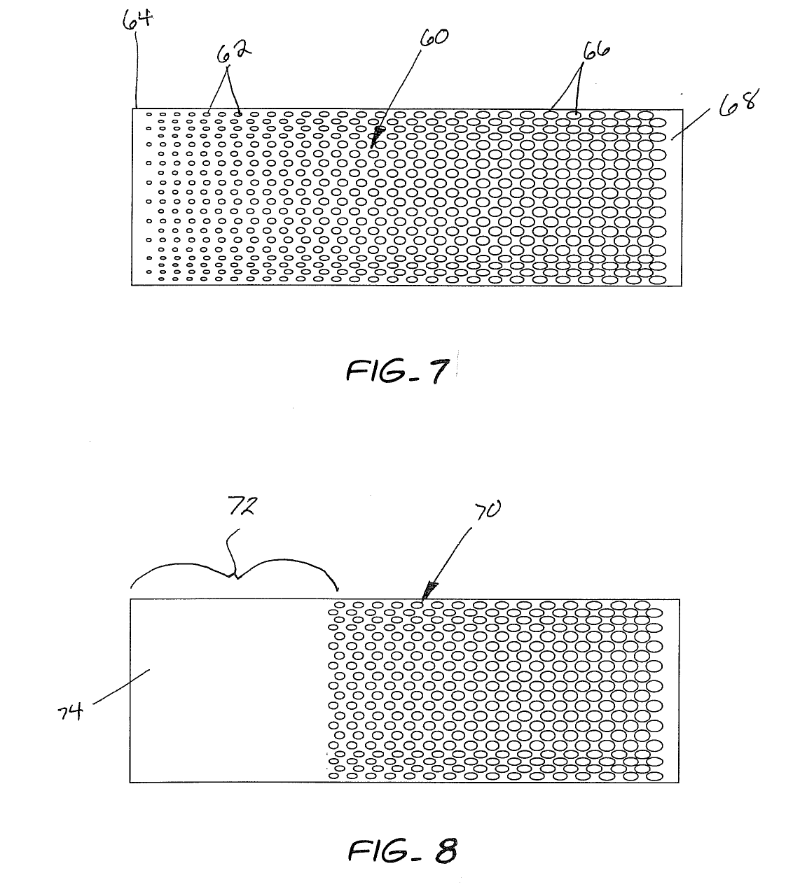

The array of through-holes 42 may be sized to allow composite fill material 22 of a desired consistency and/or particle or chunk size to fall through and be collected and removed by the output conveyor 56, which may, as shown in FIG. 5, be positioned below the drum 40 for that purpose. Alternatively, the blending apparatus 36 may include a drum 60, as shown in FIG. 7, which includes smaller holes 62 at an upstream end 64 and larger holes 66 at a downstream end 68 to insure that the composite fill material 22 is sufficiently blended and aerated before passing through the wall of the drum 60. As a further alternative, the blending apparatus 36 may include a drum 70, as shown in FIG. 8, having a drum wall section 72 toward an upstream end 74 of the drum 70 including no holes at all to further insure that the composite fill material 22 is properly blended and aerated before exiting through the drum wall. Where a trommel is used as the blending apparatus, it may be any one of a number of suitable trommels such as the 621 Trommel Screener available from McCloskey International.

The use of such a blending apparatus 36 such as a trommel type blender more uniformly blends, aerates, and distributes the moisture content of the spent lime 14 and soil 18, and may also screen out undesirable elements 38 of the mixture 22, providing a more consistent, uniform and homogeneous composite fill material 22 product. The use of such a blending apparatus 36 also provides greater control of the blending and moisture content of the fill material 22.

Once properly intermixed, the composite fill material 22 may be placed into the selected land area to create a solid soil base, as shown in FIG. 4. Typically, the selected land area 24 is a gravel pit or other depressed land area. However, the subject composite fill material 22 and method for filling may be used to build-up land areas that may or may not include depressed areas, i.e., to build mounds, berms, or hills. A front-end loader 26 or other common earth moving or excavating machinery may be used to load and carry the composite fill material 22 and deposit it at the selected location. Depending upon the final application of the filled land, it may be further necessary to compact the fill material 22 while filling. That is, the composite fill material may be rolled with heavy rollers or compressed by other suitable means intermediately between adding loads of fill material, thus creating a denser solid soil base.

The subject composite fill material 22 is relatively inexpensive due to the inexpensive nature of spent lime. Generally there is an over abundance of spent lime at municipal water treatment facilities; thus the only cost involved is usually that associated with collecting the spent lime from settling ponds and trucking it to the land site. The resulting solid soil base created by the subject method is relatively impermeable to water and will not easily erode away. Moreover, depending upon the mix ratio of soil 18 to spent lime 14, the resulting solid soil base may be specifically designed to exhibit sufficient load bearing characteristics to support land uses ranging from city parks to commercial buildings.

This is an illustrative description of embodiments of the invention and thus uses terminology that's intended to be descriptive rather than limiting.

Obviously many modifications and variations of the present invention are possible in light of the above teachings. Within the scope of the appended claims, in which reference numerals are merely for convenience and are not to be in any way limiting, the invention may be practiced otherwise than as specifically described.

What is claimed is:

1. A method for filling and/or building-up land areas, the method including the steps of:
providing a substance comprising spent lime;
providing soil;
forming a generally non-reactive composite fill material by intermixing the substance with the soil such that moisture content of the spent lime is distributed through the material; and
creating a solid soil base by depositing the composite fill material.

2. The method of claim 1 in which the step of providing a substance comprising spent lime includes generating spent lime by:
providing a solution of water and dissolved minerals;
precipitating a residue and providing softened water by adding lime to the solution;
removing the residue from the softened water; and
further processing the residue to form spent lime of a desired consistency.

3. The method of claim 2 in which the step of further processing the residue to form spent lime includes:
reducing water content of the residue by storing the residue in a containment and allowing insoluble precipitates to settle-out and form a layer of spent lime; and
removing spent lime from the layer.

4. The method of claim 2 in which the step of further processing the residue to form spent lime includes compressing the residue sufficiently to form a spent lime cake of a desired consistency and dampness.

5. The method of claim 4 in which the step of forming a spent lime cake includes compressing the residue using one or more press devices selected from the group of press devices consisting of a plate and frame press, a vacuum drum press, a belt press, and a filter press.

6. The method of claim 2 including the additional step of analyzing the spent lime for unacceptable amounts of hazardous materials.

7. The method of claim 1 in which the step of providing soil includes providing soil comprising material more coarse than the spent lime.

8. The method of claim 7 in which the step of providing soil includes providing soil comprising sand.

9. The method of claim 1 in which the step of intermixing includes the steps of:
dumping the wet spent lime in a mound;
dumping the soil in a mound;
intermixing the mounds.

10. The method of claim 1 in which the step of intermixing includes providing a tossed mixture by tossing spent lime and soil together using excavation machinery.

11. The method of claim 10 including the additional step of further blending and aerating the tossed mixture by bulldozing.

12. The method of claim 1 in which the steps of providing spent lime, soil, and intermixing include providing spent lime and soil having respective moisture contents such that intermixing provides composite fill material having an approximate 15% moisture content.

13. The method of claim 1 in which the steps of providing spent lime and soil include providing spent lime and soil at a ratio in the range of 9:1 to 1:9.

14. The method of claim 1 in which the steps of providing spent lime and soil include providing spent lime and soil at a ratio in the range of 3:2 to 2:3.

15. The method of claim 1 including the additional step of screening-out undesirable elements of the intermixed substance and soil.

16. The method of claim 15 in which the steps of intermixing and screening-out include intermixing the substance with soil within a rotating drum having a drum wall comprising holes that allow composite fill material of a desired consistency to pass through the drum wall while causing undesirable elements of the intermixed substance and soil to pass out a downstream end of the drum.

17. The method of claim 16 in which the step of intermixing within a rotating drum includes controlling a rate of axial movement of the spent lime and soil through the drum by adjusting drum tilt.

18. The method of claim 16 in which the step of intermixing with a rotating drum includes providing a drum comprising a helical blade fixed along and around an inner circumferential surface of the drum and configured to propel the spent lime and soil axially through the drum in a direction toward an outlet end of the drum and to assist in blending the spent lime and soil.

19. The method of claim 16 in which the step of intermixing with a rotating drum includes controlling a rate of drum rotation to influence one or more characteristics of spent lime and soil passing through the drum, such characteristics being selected from the list of characteristics consisting of degree of blending, moisture distribution, and degree of aeration.

20. The method of claim 16 in which the step of intermixing with a rotating drum includes providing a drum comprising smaller holes at an upstream end and larger holes at a downstream end.

21. The method of claim 16 in which the step of intermixing with a rotating drum includes providing a drum comprising no holes at an upstream end.
